(19) United States
(12) Patent Application Publication
(10) Pub. No.: US 2005/0084199 A1
(43) Pub. Date: Apr. 21, 2005

(54) Ferroelectric substrate period polarization structure manufacturing method

(76) Inventors: Junji Hirohashi, Stockholm (CH); Shiro Shichijyo, Chiba (JP)

Correspondence Address: BURNS DOANE SWECKER & MATHIS L L P, POST OFFICE BOX 1404, ALEXANDRIA, VA, 22313-1404, US

(21) Appl. No.: 10/504,983

(22) PCT Filed: Feb. 21, 2003
(86) PCT No.: PCT/JP03/01919

(30) Foreign Application Priority Data
Feb. 27, 2002 (JP) 2002-52048

(51) Int. Cl. G02B 6/12

(52) U.S. Cl. 385/14

(57) ABSTRACT

A ferroelectric substrate periodically poled structure manufacturing method for periodically reversing the polarization direction by applying an electric field between electrodes on the both surfaces of the ferroelectric substrate. An electric field is applied to a portion between the electrodes in a direction different from the spontaneous direction. Next, a step of applying the electric field in the same direction as the spontaneous polarization is performed at least once. After this, the electric field is applied in the direction different from the spontaneous polarization.

### TECHNICAL FIELD

The present invention relates to a method for manufacturing a periodically poled structure in a ferroelectric substrate which is used to form optical devices such as a wavelength conversion element, a second harmonic generation element and the like, and shows large nonlinear optical effects.

### BACKGROUND ART

Currently, wavelength conversion elements and second harmonic generation elements (hereinafter referred to as SHG) using nonlinear optical effects in oxide single crystals have been practically used. As for elements for green color generation, there can be mentioned, for example, a potassium titanyl phosphate single crystal (KTiOPO₄ single crystal; hereinafter, ┌KTP single crystal┘), a lithium triborate single crystal (LiB₃O₅ single crystal; hereinafter, ┌LBO single crystal┘), a potassium niobate single crystal (KNbO₃ single crystal; hereinafter, ┌KN single crystal┘) and the like. These elements are called a bulk type SHG element and manufactured by cutting an element at a specific angle in order to perform a desired conversion from the single crystal.

However, a bulk type SHG element possesses a relatively low SHG conversion efficiency in characteristic property thereof. Therefore, devices have been rapidly developed using high quality and cheap crystals which could be obtained from a lithium niobate single crystal (LiNbO₃ single crystal; hereinafter, ┌LN single crystal┘) or a lithium tantalate single crystal (LiTaO₃ single crystal; hereinafter, ┌LT single crystal┘). Furthermore, in order to obtain devices having high conversion efficiency, it would be better to have the phase propagation speed of a fundamental wave and a second harmonic to be equal. In order to perform this in a quasi manner, there has been proposed a method to arrange + and − of nonlinear optical coefficients periodically (A. Armstrong, N. Bloembergen, et al., Phys. Rev., 127, 1918 (1962)). To realize this, there has been a method to invert the crystal polarization periodically. To easily perform this, there has been proposed a method to form electrodes on the surface of a substrate and to manufacture a polarization structure in which the polarization is inverted periodically by applying an electric field (JP05-210133A). However, as for an LN single crystal and LT single crystal, the electric field (inversion electric field) necessary for inverting its polarization has been very high, i.e., 20 kV/mm or more so that a substrate has been broken in the production of a periodically poled structure in many cases. In addition, in the LN single crystal and LT single crystal, if the time has been passed for a long time for an optical output shape, there were problems of optical damage resulting in changing the optical output shape and of a device operation being in trouble as well. Meanwhile, in order to solve these problems, there has been proposed a method to dope LN and LT with Mg or Zn. However, the growth of these crystals tended to easily cause non-uniformity and defects in crystals because of an increase in the kind of component elements.

A cross sectional photograph of the periodically poled structure that was manufactured according to the conventional method is illustrated in FIG. 10(a). As shown in the drawing, non-inverted area tended to appear on the substrate and non-uniformity tended to occur in the periodically poled structure.

Further, of the same ferroelectrics, orthorhombic crystals such as a KN single crystal or KTP single crystal have the inversion electric field of 4 kV/mm or less. Especially in a KN single crystal, the inversion electric field is very low, i.e., 250V/mm. Also, no optical damages have been occurred so that the ferroelectric substrate manufactured by controlling a polarization structure of these crystals are very useful as a wavelength conversion element or a SHG element. However, it was difficult to make these crystals to be large-scale products and it was difficult to control non-uniformity, defects, mixing of impurities or the like.

In the course of manufacturing a ferroelectric substrate in which a polarization direction is periodically inverted, if the polarization-inverted area becomes large, non-uniformity occurs in concentration of the electric field within the surface during manipulation of inversion. FIG. 11 illustrates a cross sectional diagram of the substrate in this case. As shown in the diagram of FIG. 11, firstly, it is considered that cores 21 are generated at an electric field-concentrated parts where the polarization inversion of these parts is progressed in the first place. Further, such core generation is dependent on impurities, or non-uniformity of defects as well. The core refers to a minute area where an electric field is easily applied regionally when an electric field is equally applied to all areas of the substrate.

Thus, a substrate in which the polarization has never been inverted could not control the core generation due to impurities or defects. As a result, non-uniformity has occurred at the inversion area in which an inversion in a shape of island has occurred. In particular, as for oxide single crystals such as an LN single crystal, LT single crystal, KN single crystal, KTP single crystal and the like, the composition is contrary to the stoichiometric ratio so that it is extremely difficult to control the distribution of impurities and defects. In addition, in a KN single crystal, KTP single crystal or the like in which it was difficult for the large crystal growth, it was even more difficult to control the distribution of non-uniformity, impurities and defects, and non-uniformity of the core generation became conspicuous. So, it was difficult to manufacture elements that were highly efficient and stable.

### DISCLOSURE OF THE INVENTION

An object of the present invention is to solve problems caused by the conventional art as described above and also to provide a method for manufacturing a uniform polarization structure in which non-uniformity of the inversion occurred in the production of a periodically poled structure is suppressed and non-uniformity of an inversion area is small.

According to the present invention, a method for manufacturing a periodically poled structure in a ferroelectric substrate wherein an electrode-formed substrate having electrodes respectively on both surfaces of the ferroelectric substrate in which a spontaneous polarization is arranged in one polarization direction and having electrodes on at least one surface formed in the teeth of comb at a predetermined distance in the surface direction is used, and an electric field is applied between electrodes on both surfaces of the substrate to form a structure such that the polarization direction is periodically inverted,

wherein a process of applying the electric field in the direction different from a spontaneous polarization between the electrodes and then applying the electric field in the same direction as the spontaneous polarization between the electrodes is performed at least one or more times, and the electric field is further applied in the direction different from the spontaneous polarization.

Further, according to the present invention, a method for manufacturing a periodically poled structure in a ferroelectric substrate wherein an electrode-formed substrate having electrodes respectively on both surfaces of the ferroelectric substrate in which a spontaneous polarization is arranged in one polarization direction and having electrodes on at least one surface formed in the teeth of comb at a predetermined distance in the surface direction is used, and an electric field is applied between electrodes on both surfaces of the substrate to form a structure such that the polarization direction is periodically inverted,

wherein the electric field is applied in the direction different from the spontaneous polarization between the electrodes and the electric field is further applied in the same direction as the spontaneous polarization.

Further, it is desirable that before the electric field is applied in the direction different from the spontaneous polarization, a process of applying an electric field in the direction different from the spontaneous polarization and then applying the electric field in the same direction as the spontaneous polarization is performed repeatedly at least one or more times.

It is desirable that the electrode-formed substrate is a substrate which insulating layers and/or pattern electrodes are formed on the surface thereof. It is desirable that the angle between the spontaneous polarization direction and the inverted polarization direction is 60°, 90°, 120° or 180°.

Further, it is desirable that the ferroelectric substrate is an oxide single crystal.

It is desirable that the oxide single crystal is a single crystal which is formed from lithium niobate, lithium tantalate or a compound mixing transitional metal with these. Also, it is desirable that the oxide single crystal is an orthorhombic crystal or a tetragonal crystal.

Furthermore, the oxide single crystal is a potassium niobate single crystal, a potassium titanyl phosphate single crystal, a lithium triborate single crystal or a barium titanate single crystal.

### BRIEF DESCRIPTION OF THE DRAWINGS

FIG. 1 is a schematic sectional view of a manufacturing device used for manufacturing a periodically poled structure in a ferroelectric substrate according to the present invention.

FIG. 2 is a flow chart illustrating a conventional method for manufacturing a polarization structure and a process of a method for manufacturing a periodically poled structure according to the present invention.

FIG. 3 a schematic perspective view illustrating a periodically poled structure in a ferroelectric substrate manufactured by a method for manufacturing a periodically poled structure according to the present invention.

FIG. 4 is a diagram illustrating a waveform of an electric field in the manufacture of a periodically poled structure in a ferroelectric substrate according to the present invention.

FIG. 5 is a graph illustrating a relationship between the frequency of uniform core generating processes and intensity of inversion-initiating electric field in a KNbO₃ single crystal substrate.

FIG. 6 is a transmission perspective diagram of the substrate illustrating cores generated by repeatedly performing the first uniform core generating process and the second uniform core generating process on a KNbO₃ single crystal substrate.

FIG. 7 is a transmission perspective diagram illustrating polarization areas and cores of a substrate upon termination of each process in a method (a) for manufacturing a periodically poled structure according to the present invention.

FIG. 8 is a transmission perspective diagram illustrating polarization areas and cores of a substrate upon termination of each process in a method (c) for manufacturing a periodically poled structure according to the present invention.

FIG. 9 is a diagram illustrating examples of electric field waveforms in methods (a) and (c) for manufacturing a periodically poled structure according to the present invention.

FIG. 10 is a cross sectional photograph illustrating an inverted state of a periodically poled structure manufactured by a conventional method and a cross sectional photograph illustrating an inverted state of a periodically poled structure obtained by a manufacturing method according to the present invention.

FIG. 11 is a cross sectional diagram illustrating a polarization structure of a substrate manufactured by a conventional method for manufacturing a periodically poled structure.

FIG. 12 is a transmission perspective diagram illustrating polarization areas and cores of a substrate in a conventional method for manufacturing a periodically poled structure.

FIG. 13 is an enlarged schematic cross sectional view of one manufacturing process in method for manufacturing a polarization structure according to the present invention.

FIG. 14 is a diagram of a polarization structure manufactured by the present invention.

FIG. 15 is a transmission microscopic photograph illustrating a forming state of a periodically poled structure obtained by a method according to the present invention.

### BEST MODE FOR CARRYING OUT THE INVENTION

The present invention will be described in more detail below.

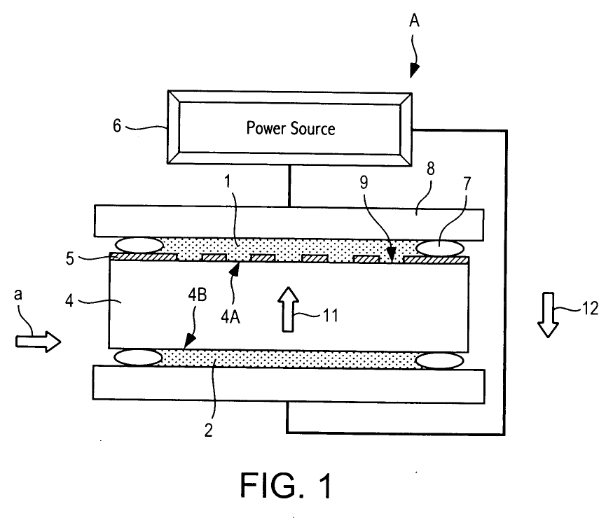

A method for manufacturing a periodically poled structure in a ferroelectric substrate according to the present invention is described with reference to a schematic cross sectional view of FIG. 1 illustrating an example of a manufacturing device in use.

As illustrated in FIG. 1, a number A refers to a device for manufacturing a periodically poled structure in a ferroelectric substrate (hereinafter referred to as [manufacturing device] in short).

A manufacturing device A basically has a power source 6, a ferroelectric substrate 4 to be processed, insulating layers 5 to be formed on an upper surface 4A of the ferroelectric substrate 4, a first liquid electrode 1 and a second liquid electrode 2 applying an electric field to the ferroelectric substrate 4 between the ferroelectric substrate 4 and the acryl plates 8.

On the ferroelectric substrate 4 before processing, a spontaneous polarization is generally formed in the polarization direction 11 in advance. On the upper surface 4A of the ferroelectric substrate 4, the insulating layers 5 are formed from a pattern coated with photo resist and manufactured by a photolithography method. The insulating layers 5 are formed in the teeth of comb at a predetermined distance from the surface direction (direction of longitudinal axis) a of the ferroelectric substrate 4. The film thickness of the insulating layers 5 is not particularly restricted, but preferably in a range of 5 to 20 μm.

In this example, the ferroelectric substrate 4 is disposed between the acryl plates 8 through silicon rubbers 7. The first liquid electrode 1 and the second liquid electrode 2 are filled between the acryl plates 8 and the ferroelectric substrate 4. When filling, adjustment is made such that no bubble remains on the surface of the ferroelectric substrate 4 by a bubble-removing processing.

The first liquid electrode 1 is in contact with a portion on the upper surface 4A of the ferroelectric substrate 4 in which no insulating layer 5 is formed on its surface, thus forming a pattern electrode 9. Furthermore, the second liquid electrode 2 is in contact with the bottom surface 4B of the ferroelectric substrate 4, thus forming an electrode-formed substrate.

Width of this pattern electrode 9, width of the insulating layers 5 or the distance between the first liquid electrode 1 and the second liquid electrode 2 (that is, the thickness of the ferroelectric substrate 4) are not particularly restricted because they are different depending on the type of the oxide single crystal and device design for use in the ferroelectric substrate 4.

As for the first liquid electrode 1 and the second liquid electrode 2, there can be mentioned saturated aqueous solutions such as LiCl, KCl and the like.

Furthermore, as for pattern electrodes, for example, a photolithography method is used for the manufacture of its patterns, metal electrodes such as aluminum, gold and the like, which is further manufactured by a liftoff method, or electrodes manufactured in combination with insulating layers and metal electrodes can be used.

These pattern electrodes may be formed either on the upper surface or the bottom surface of the ferroelectric substrate, or on both surfaces.

The ferroelectric substrate 4 to be processed using this manufacturing device A is made of oxide single crystal materials having single domain polarization. As for oxide single crystal materials, trigonal crystals such as an LN single crystal, LT single crystal and the like; orthorhombic crystals such as a KN single crystal, KTP single crystal, LBO single crystal, rubidium titanyl phosphate single crystal (RbTiOPO₄ single crystal) and the like; tetragonal crystals such as a barium titanate single crystal (BaTiO₃ single crystal) and the like can be used. Furthermore, a single crystal that is formed from a compound mixing transitional metals such as Mg, Zn or the like with lithium niobate or lithium tantalate can be used as well.

Further, as for the ferroelectric substrate 4, a substrate in which a thin film made of the same material as the ferroelectric substrate is epitaxially grown thereon can be used.

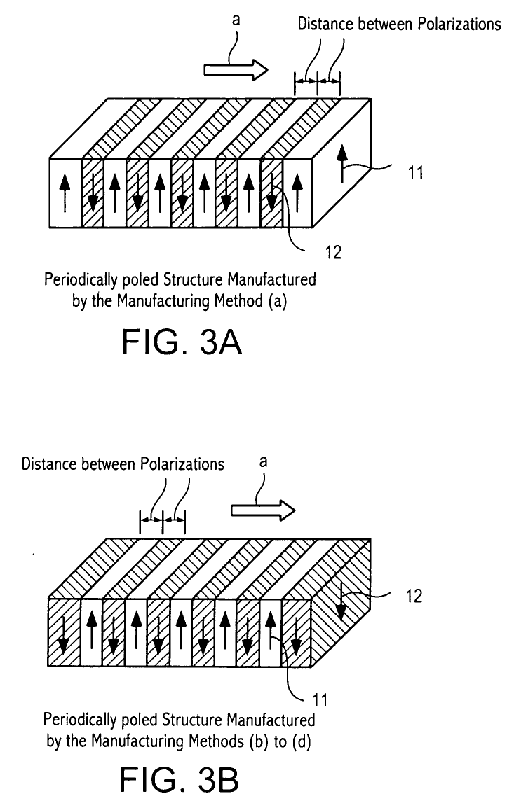

The ferroelectric substrate 4 in this manner is not particularly restricted, but its shape can be a rectangular column shape, a flat board shape and the like. By setting the ferroelectric substrate 4 to the manufacturing device A, a periodically poled structure of the ferroelectric substrate according to the present invention is manufactured. The periodically poled structure, as shown in, for example, FIG. 3, the polarization direction of a crystal in the substrate is perpendicular to the substrate surface or has a predetermined angle (not shown in the drawings), and further the inverted polarization structure is formed periodically on the substrate.

In FIG. 1, the periodically poled structure is described such that said spontaneous polarization direction 11 and the polarization direction inverted to the direction 12 different from the spontaneous polarization direction 11 is formed at an angle of 180°. However, the periodically poled structure having the inverted polarization direction at an angle of 60°, 90° or 120° can be manufactured.

A method for manufacturing a periodically poled structure in a ferroelectric substrate according to the present invention is not particularly restricted, but preferably the following methods (a) to (d) can be mentioned in detail.

Each manufacturing method will be described below with reference to the manufacturing device A shown in FIG. 1.

Manufacturing Method (a)

First, in a manufacturing method (a), an electric field is applied to the direction 12 different from the spontaneous polarization direction 11 of the ferroelectric substrate 4 in the manufacturing device A to which the ferroelectric substrate 4 shown in FIG. 1 is set such that the first liquid electrode 1 becomes a positive potential and the second liquid electrode 2 becomes a negative potential. The electric field is applied such that potential difference between these positive potential and negative potential becomes greater than an electric field initiating a polarization inversion (positive inversion-initiating field) to the direction 12 inverted at an angle of 180° from the spontaneous polarization direction 11 (hereinafter referred ┌to as first uniform core generating processes┘).

Next, an electric field is applied in the same direction as the spontaneous polarization direction 11 such that the first liquid electrode 1 becomes a negative potential and the second liquid electrode 2 becomes a positive potential. The electric field is applied such that potential difference between these positive potential and negative potential becomes greater than an electric field that the polarization inverted to the direction 12 initiates an inversion to the spontaneous polarization direction 11 once again (reverse inversion-initiating field) (hereinafter referred to as ┌second uniform core generating processes┘).

For the ferroelectric substrate 4, the first uniform core generating process is performed and then the second uniform core generating process is performed repeatedly more than one time, preferable 1 to 50 times, and more preferably 1 to 25 times.

Thus, non-uniformity of the inversion occurred in the production of the periodically poled structure can be suppressed by performing the polarization inversion repeatedly under these conditions, which cannot be avoided by the conventional method.

Then, in the manufacturing method (a), an electric field is applied in the direction 12 such that the liquid electrode 1 becomes a positive potential and the liquid electrode 2 becomes a negative potential. The applied electric field at this time is applied such that potential difference between these positive potential and negative potential is greater than the positive inversion-initiating electric field (hereinafter referred to as ┌positive pattern forming process┘).

According to the manufacturing method (a), it is possible to manufacture a ferroelectric substrate having a uniform polarization structure in which non-uniformity of the inversion area is small. FIG. 3 illustrates a schematic perspective view of a periodically poled structure in a ferroelectric substrate thus manufactured.

Manufacturing Method (b)

First, in a manufacturing method (b), an electric field is applied to the direction 12 different from the spontaneous polarization direction 11 of the ferroelectric substrate 4 in the manufacturing device A to which the ferroelectric substrate 4 shown in FIG. 1 is set such that the liquid electrode 1 becomes a positive potential and the liquid electrode 2 becomes a negative potential. The electric field is applied such that potential difference between these positive potential and negative potential becomes greater than the positive inversion-initiating electric field initiating the polarization inversion to the direction 12 inverted at an angle of 180° from the spontaneous polarization direction 11 (hereinafter referred to as ┌third uniform core generating process┘).

By performing the third uniform core generating process under these conditions, it is considered that the spontaneous polarization of all areas of the ferroelectric substrate 4 is polarization-inverted to the direction 12. Further, non-uniformity of the inversion occurred in the production of the periodically poled structure can be suppressed by performing the third uniform core generating process.

Next, in the manufacturing method (b), an electric field is applied in the spontaneous polarization direction 11 such that the first liquid electrode 1 becomes a negative potential and the second liquid electrode 2 becomes a positive potential. The applied electric field at this time is applied such that potential difference between the positive potential and negative potential is greater than the reverse inversion-initiating electric field (hereinafter referred to as ┌negative pattern forming process┘).

According to this manufacturing method (b), it is possible to manufacture a uniform polarization structure in which non-uniformity of the inversion area is small. FIG. 3 illustrates a schematic perspective view of a periodically poled structure in a ferroelectric substrate thus manufactured.

Manufacturing Method (c)

First, in a manufacturing method (c), a polarization inversion process is performed, in which the first uniform core generating process is performed and then the second uniform core generating process is performed in the same manner as described above.

This polarization inversion process is performed repeatedly more than one time, preferably 1 to 50 times, and more preferably 1 to 25 times. Non-uniformity of the inversion occurred in the production of the periodically poled structure can be suppressed by performing the polarization inversion process repeatedly under these conditions.

Then, in this manufacturing method (c), the third uniform core generating process is performed and the negative pattern forming process is further performed in the same manner as described above.

According to the manufacturing method (c), it is possible to manufacture a uniform polarization structure in which non-uniformity of the inversion area is small. FIG. 3 illustrates a schematic perspective view of a periodically poled structure in a ferroelectric substrate thus manufactured.

Manufacturing Method (d)

First, in a manufacturing method (d), a polarization inversion process is performed in which the third uniform core generating process is performed and then the second uniform core generating process is performed in the same manner as described above.

This polarization inversion process is performed repeatedly more than one time, preferably 1 to 50 times, and more preferably 1 to 25 times.

Non-uniformity of the inversion occurred in the production of the periodically poled structure can be suppressed by performing the polarization inversion process repeatedly under these conditions.

Then, the third uniform core generating process is performed and the negative pattern forming process is further performed in the same manner as described above.

According to the manufacturing method (d), it is possible to manufacture a uniform polarization structure in which non-uniformity of the inversion area is small. FIG. 3 illustrates a schematic perspective view of a periodically poled structure in a ferroelectric substrate thus manufactured.

In the first uniform core generating process, the second uniform core generating process, the third uniform core generating process, the positive pattern forming process and the negative pattern forming process, the field intensity and the applied time thereof are different depending on the type of the oxide single crystal that can be used for the ferroelectric substrate 4.

Concretely, in case the oxide single crystal is a KN single crystal, it is desirable that in the first uniform core generating process and the second uniform core generating process, an electric field having a maximum electric field of 250 to 500 V/mm and preferably 300 to 350 V/mm is applied for 1 to 10 seconds and preferably for 2 to 4 seconds. The maximum electric filed and the applied time may be in any combination therewith (identically applied to any of processes). It is desirable that in the third uniform core generating process, an electric field having a maximum electric field of 250 to 500 V/mm and preferably 300 to 350 V/mm is applied for 1 to 10 seconds and preferably for 3 to 6 seconds. It is desirable that in the positive pattern forming process, an electric field having a maximum electric filed of 250 to 500 V/mm and preferably 300 to 350 V/mm is applied for 3 to 100 ms and preferably for 5 to 50 ms. It is desirable that in the negative pattern forming process, an electric field having a maximum electric filed of 250 to 500 V/mm and preferably 300 to 350 V/mm is applied for 3 to 100 ms and preferably for 5 to 50 ms.

By performing the first uniform core generating process, the second uniform core generating process, the third uniform core generating process, the positive pattern forming process and the negative pattern forming process under the above conditions, it is possible to manufacture a uniform polarization structure in which non-uniformity of the inversion area is small.

Furthermore, if the oxide single crystal is an LN single crystal, LT single crystal or a single crystal formed from a compound mixing transitional metal such as Mg, Zn or the like with these, it is desirable that the electric field is applied such that the maximum electric field is 1 to 2 times as much as the inversion-initiating electric field and preferably 1 to 1.4 times. Further, the applied time is the same as that of the KN single crystal. By applying an electric field under these conditions, it is possible to manufacture a uniform polarization structure in which non-uniformity of the inversion area is small.

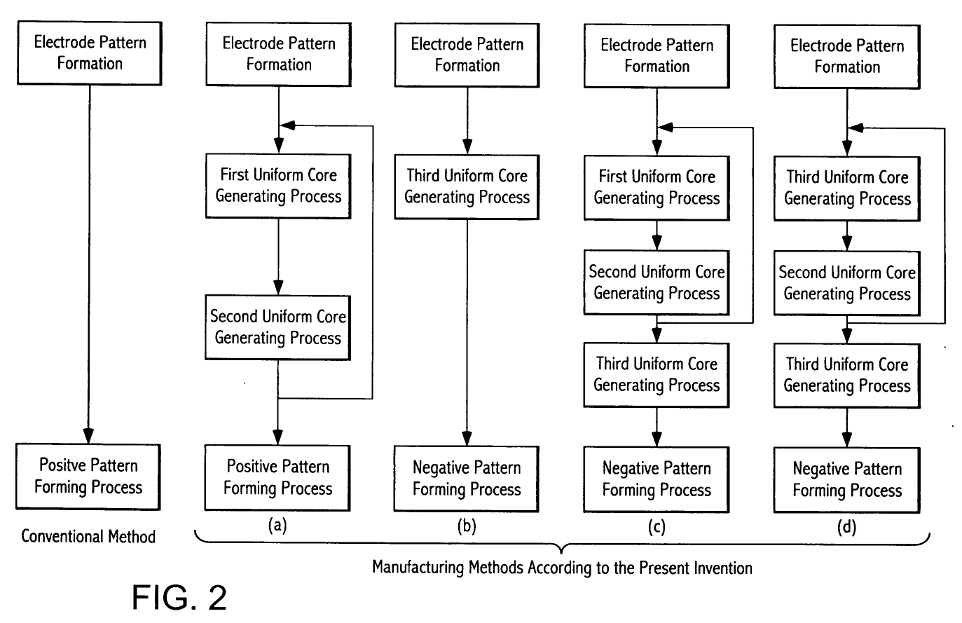

FIG. 2 is a flow chart comparing manufacturing methods (a) to (d) according to the present invention as described above with the conventional method.

In these manufacturing methods (a) to (d), the electric field used in the first uniform core generating process, the second uniform core generating process and the third uniform core generating process is illustrated in any of electric field waveforms such as a pyramidal waveform, a sine waveform or a square waveform, with time as the horizontal axis and electric field as the vertical line. Further, as for the electric field waveform used in the positive pattern forming process and the negative pattern forming process, a square waveform can be mentioned.

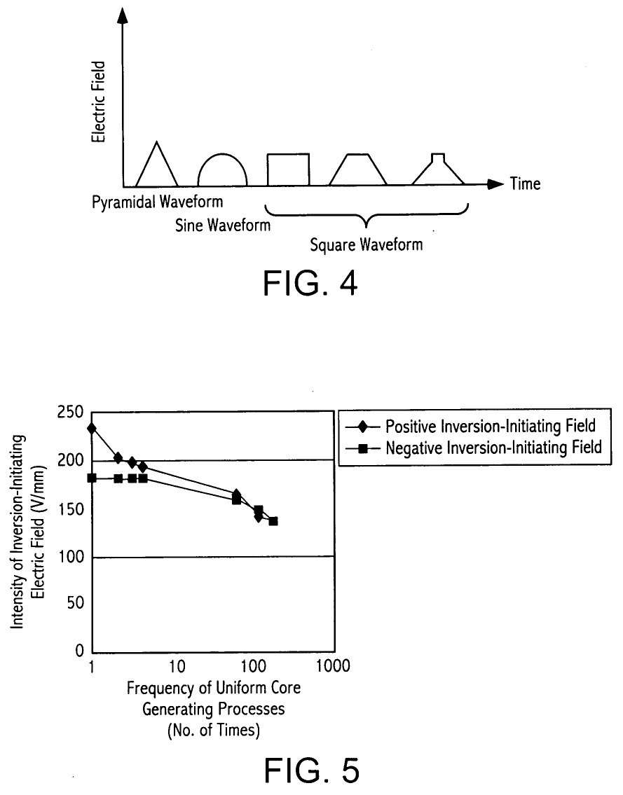

These electric field waveforms are not particularly restricted thereto. However, more concretely, the waveforms as shown in FIG. 4 can be exemplified. Even though any of these electric field waveforms is illustrated, it is desirable that an electric field greater than the electric field initiating the polarization inversion as described above is applied and the electric field is applied until the current flowing during the inversion becomes zero. If the electric field is applied under these conditions, breakage of the ferroelectric substrate 4 or generation of undesirable domain due to abrupt change in the electric field can be avoided.

The ferroelectric substrate having a periodically poled structure manufactured in the manner described above has a periodic polarization structure in the surface direction (direction of longitudinal axis) a of the substrate 4 as shown in FIG. 3 and further has a uniform polarization structure in which non-uniformity is small. The distance between these polarizations is a value to be determined depending on aiming device design.

The ferroelectric substrate having this periodically poled structure has great nonlinear optical effects, which is used for forming optical devices such as a wavelength conversion element, a second harmonic generation element or the like. Further, the ferroelectric substrate obtained according to the present invention can improve productivity and uniformity of these optical devices as it has a polarization structure in which non-uniformity of the inversion period is small and the polarization direction is uniform within the same polarization area.

According to methods for manufacturing a periodically poled structure in the present invention as described above, it is possible to form a polarization structure in which non-uniformity of a shape of a pattern forming area is small.

This is considered possible for reasons described below.

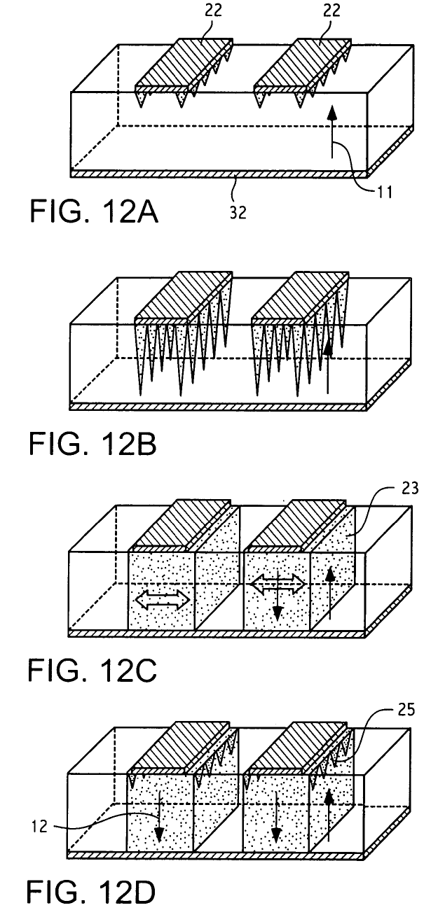

Until now, 4 processes shown in FIG. 12 have been known for an inversion process of a spontaneous polarization (R. G. Batchko, G. D. Miller et al., SPIE, 3610, 43 (1999), R. G. Batchko, M. M. Fejer et al., Opt. Lett., 24, 1293 (1999)). FIG. 12 is a transmission perspective diagram illustrating the polarization of a substrate and core forming state in the conventional method for manufacturing a periodically poled structure.

First, as shown in FIG. 12(a), a single crystal substrate having a single polarization in the spontaneous polarization direction 11 is prepared. Pattern electrodes 22 are arranged on one surface (upper surface) thereof, an electrode 32 is arranged on the opposite surface (bottom surface), and an electric field is applied such that the negative side of the spontaneous polarization becomes a negative potential and the positive side becomes a positive potential between the pattern electrodes 22 and the electrode 32.

An inversion process of the spontaneous polarization at this time comprises generating cores 21 on the edges of the electrodes 22 on which an electric field concentrates as shown in FIG. 12(a), growing the generated cores 21 as shown in FIG. 12(b), and further forming a domain wall 23 as shown in FIG. 12(c) and expanding the domain wall 23. Then, an area where the polarization is inverted to the direction 12 different from the spontaneous polarization is expanded.

When application of an electric field is terminated before a desired area is stabilized in a state of the polarization direction 12 different from the spontaneous polarization, it is known that cores 25 returning to the spontaneous polarization direction 11 occur and a back-switch phenomenon returning to the spontaneous polarization direction 11 occurs, as shown in FIG. 12(d).

The cores 21 is generated at a place where an electric field easily concentrates. The place where an electric field easily concentrates is dependent upon the shape of the pattern electrodes 22 and further upon the distribution of non-uniformity, defects and impurities in a crystal. Concentration of the electric field depending on the shape of the pattern electrode 22 easily occurs especially at the edge of the pattern electrode 22 so that it can be controlled by improving the shape of the pattern electrode 22. On the other hand, concentration of the electric field depending on the distribution of defects, non-uniformity and impurities in a crystal can not be controlled only by the shape of the pattern electrode 22 as the distribution of these and the like are determined at the time of crystal growth. Thus, it has been extremely difficult to eliminate non-uniformity of the core-generated area up to now.

In the meantime, it has been reported that cores have been generated not only on areas other than the surface directly under the electrode but also inside the substrate (V. Gopalan and T. E. Mitchell, J. Appl. Phys., 83, 941 (1998)).

However, the stability and places of cores generated by applying an electric field, accumulation and extinction of cores by applying voltage cyclically are not known. Because a very high electric field is applied for oxide single crystals such as an LN single crystal, LT single crystal and the like on which many studies have commonly been conducted, and a voltage is applied cyclically, which easily causes a damage and breakdown in the crystal. Thus, the inventors have used a KNbO₃ crystal in which an electric field necessary for inverting the polarization direction was extremely low and carried out an experiment on the accumulation effects of cores by repeatedly applying this electric field.

The manufacturing device A of the ferroelectric substrate illustrated in FIG. 1 is used for explanation.

A KN crystal substrate having a single polarization in the spontaneous polarization direction 11 is prepared, the pattern electrode 22 is arranged on one surface (upper surface) of the substrate and the pattern electrode 9 formed from the first liquid electrode 1 is arranged on the opposite surface (bottom surface), and the second liquid electrode 2 is arranged on the reverse surface thereof at the same time. Then, an electric field is applied in the direction 12 such that the negative side of the spontaneous polarization becomes a negative potential and the positive side becomes a positive potential between the pattern electrode 9 and the second liquid electrode 2 to invert the polarization direction (first uniform core generating process). Next, an electric field is applied such that the negative side of the spontaneous polarization becomes a positive potential and the positive side becomes a negative potential to invert the polarization direction again (second uniform core generating process). A series of these processes have been repeated to investigate the change in the positive inversion-initiating field that the spontaneous polarization direction 11 initiates its polarization inversion to the direction 12 and reverse inversion-initiating electric field that the polarization in the direction 12 initiates its inversion to the spontaneous polarization direction 11.

The results are shown in FIG. 5. The positive inversion-initiating electric field and reverse inversion-initiating electric field can be considered as those corresponding to the electric field necessary for core generation. Surprisingly, it was revealed that as the frequency of said processes was increased, the positive inversion-initiating electric field and reverse inversion-initiating electric field became low, and in particular, the positive inversion-initiating electric field became remarkably low.

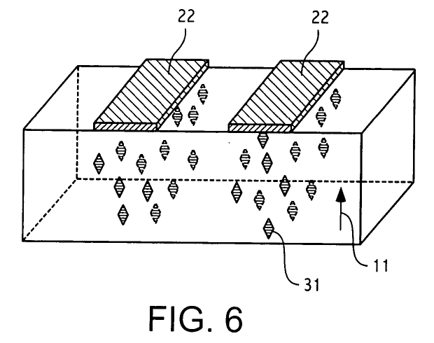

These results can be, as shown in FIG. 6, explained by means of a transmission perspective diagram of the substrate obtained by the above experiment. As shown in FIG. 6, in case the frequency of repeated polarization inversions is increased, the cores 31 generated by application of the electric field do not disappear even after the termination of applying the electric field and are accumulated not only inside the crystal but also on the surface of the crystal. Thus, it can be considered that the positive inversion-initiating electric field and reverse inversion-initiating electric field upon application of the electric fields repeatedly are gradually decreased. That is, it is considered that this inversion-initiating electric field is decreased as the energy necessary for core generation is decreased by the accumulation effects of said cores 31. Furthermore, if the first uniform core generating process and the second uniform core generating process are repeated, it is expected that the size of the inversion-initiating electric field be reduced finally up to the electric field necessary for a process after a core generating process, i.e., a core growing process shown in FIG. 12(b).

Further, surprisingly, when confirming the polarization state by etching with hydrofluoric acid after conducting the third uniform core generating process, it was confirmed that its inversion to the direction different from the spontaneous polarization occurred not only directly under the electrodes but also in all areas where the electrode was not formed. Said results show that the generated cores 31 illustrated in a diagram of FIG. 6 by the third uniform core generating process are accumulated on all over the desired pattern forming area.

Based on the facts as described above, examples of the manufacturing methods (a) and (c) are described with reference to the drawings regarding methods for manufacturing the polarization structure according to the present invention.

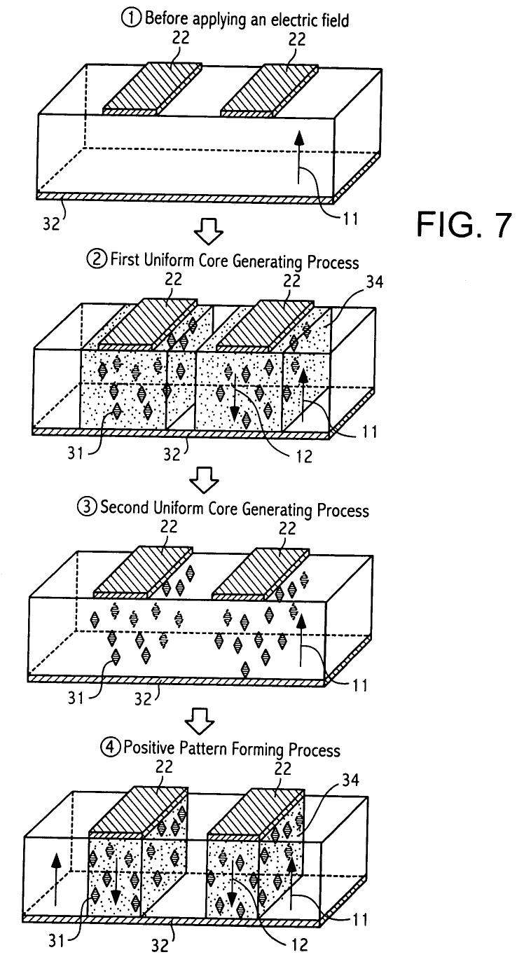

FIG. 7 is a transmission perspective diagram illustrating polarization areas and cores in a substrate upon termination of each process in the manufacturing method (a) as described above.

In the manufacturing method (a), as shown in FIG. 7\mathring{1}, desired pattern electrodes 22 are provided on one surface of the single crystal arranged in the spontaneous polarization direction 11 and an electric field is applied between the pattern electrode 22 and the electrode 32 on the other surface.

First, in the manufacturing method (a) illustrated in FIG. 7, the first uniform core generating process applying an electric field in the direction 12 different from the spontaneous polarization is performed.

FIG. 7\mathring{2} is a transmission perspective diagram of the polarization state upon termination of the first uniform core generating process and the distribution of the generated cores 31. As shown in FIG. 7\mathring{2}, the cores 31 are formed in a dot shape at a polarization-inverted area 34 to the direction 12.

Furthermore, the second uniform core generating process applying an electric field in the spontaneous polarization direction 11 is performed.

FIG. 7\mathring{3} is a diagram illustrating the polarization state upon termination of the second uniform core generating process and the distribution of cores 31. As shown in FIG. 7\mathring{3}, the polarization direction is returned to the spontaneous polarization direction 11 over the whole area; however, cores 31 are accumulated on the area 34 where the polarization is inverted to the direction 12 in the first uniform core generating process. It is considered that cores 31 that are accumulated inside are even more increased by repeating the first uniform core generating process and the second uniform core generating process.

As cores 31 are increased, it is considered that the polarization inversion-initiating electric field becomes lowered and a uniform periodically poled structure can be manufactured, in which non-uniformity of the inversion area is small.

Then, the positive pattern forming process applying an electric field in the direction 12 different from the spontaneous polarization is performed. FIG. 7\mathring{4} illustrates the polarization state upon termination of the positive pattern forming process and the distribution of cores 31. Areas under the pattern electrodes 22 are polarization-inverted to the direction 12 while other areas are in the spontaneous polarization direction 11. It is possible to obtain a desired uniform periodically poled structure in which cores 31 are formed in a dot shape in the polarization-inverted area 34 to the direction 12 and non-uniformity due to the places of the pattern electrodes 22 is small by performing the first uniform core generating process.

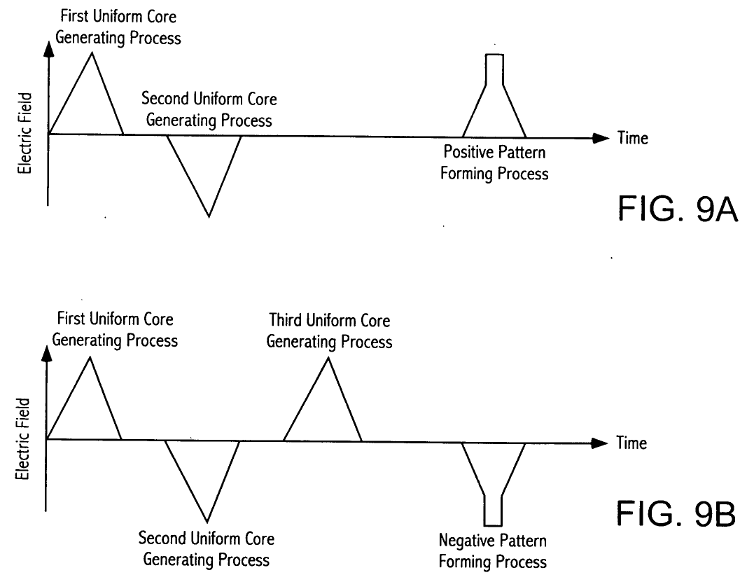

Further, as an example of a method for applying the electric field corresponding to each process illustrated in FIG. 7, FIG. 9(a) shows a schematic diagram illustrating an example of electric field waveform of the pattern electrode 22 (positive electrode) to the electrode 32 (negative electrode) facing thereto.

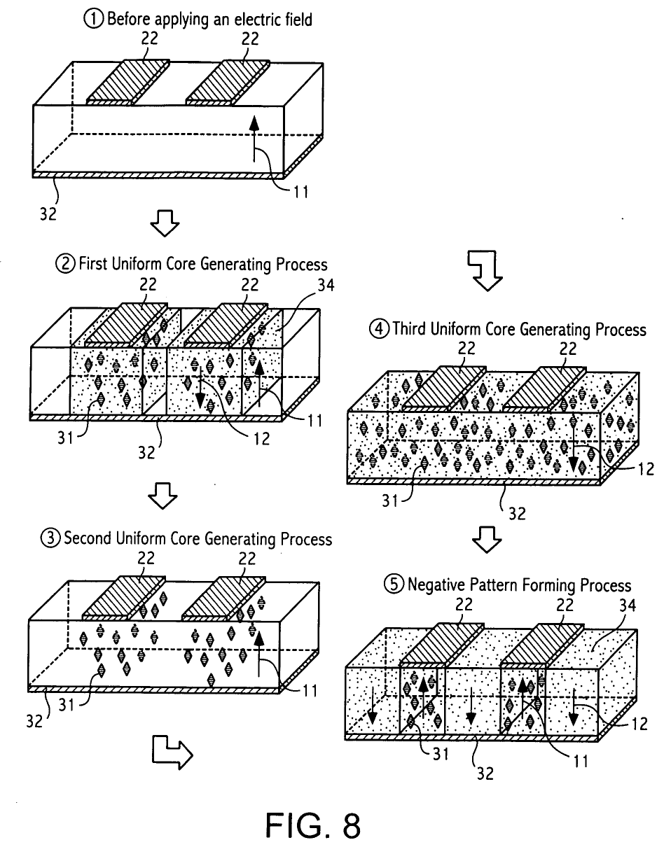

FIG. 8 is a transmission perspective diagram illustrating polarization areas and cores of a substrate upon termination of each process in the above manufacturing method (c).

In the manufacturing method (c), as shown in FIG. 8\mathring{1}, desired pattern electrodes 22 are provided on one surface of the single crystal arranged in the spontaneous polarization direction 11 and an electric field is applied between the pattern electrodes and the other surface 32 facing thereto.

First, in the manufacturing method (c) as illustrated in FIG. 8, the first uniform core generating process applying an electric field in the direction 12 different from the spontaneous polarization is performed.

FIG. 8\mathring{2} is a transmission perspective diagram of the polarization state upon termination of the first uniform core generating process and the distribution of the generated cores 31. The cores 31 are formed in a dot shape at the polarization-inverted area 34 to the direction 12.

Furthermore, the second uniform core generating process applying an electric field in the same direction 11 as the spontaneous polarization is performed.

FIG. 8\mathring{3} is a model diagram illustrating the polarization state upon termination of the second uniform core generating process and the distribution of cores 31. The polarization direction is returned to the spontaneous polarization direction 11 over the whole area; however, cores 31 are accumulated on the area 34 where the polarization is inverted to the direction 12 in the first uniform core generating process.

It is considered that cores 31 accumulated inside are even more increased by repeating the first uniform core generating process and the second uniform core generating process. As cores 31 are increased in this manner, it is considered that the polarization inversion-initiating electric field becomes lowered and a uniform periodically poled structure can be manufactured, in which non-uniformity of the inversion area is small.

Then, the third uniform core generating process applying an electric field in the direction 12 different from the spontaneous polarization is performed.

FIG. 8\mathring{4} is a schematic diagram illustrating the polarization state upon termination of the third uniform core generating process and the distribution of cores 31. All areas are polarization-inverted to the direction 12 and further the cores 31 are formed in a dot shape over the whole area inside the crystal (substrate) as well.

Then, the negative pattern forming process applying an electric field in the spontaneous polarization direction 11 is performed.

FIG. 8\mathring{5} illustrates the polarization state upon termination of the negative pattern forming process and the distribution of cores 31. Areas under the pattern electrodes 22 are polarization-inverted to the spontaneous polarization direction 11 once again while other areas have its polarization direction in the direction 12. By performing the third uniform core generating process, it is possible to obtain a desired uniform polarization structure in which cores 31 are formed in a dot shape at an area having the first polarization direction 11 and non-uniformity due to the place of the pattern electrode 22 is small.

Further, as an example of a method for applying the electric field corresponding to each process illustrated in FIG. 8, FIG. 9(c) shows a schematic diagram illustrating an example of electric field waveform of the pattern electrode 22 (positive electrode) to the electrode 32 (negative electrode) facing thereto.

As described above, non-uniformity of the core-generated area being a problem until now can be solved by performing the third uniform core generating process at least one or more times. So, cores are generated in the positive pattern forming process or the negative pattern forming process without greatly depending on the distribution of non-uniformity, defects or impurities. Due to this function, it is considered that a desired periodically poled structure can be manufactured according to design and further a uniform periodically poled structure can be formed, in which non-uniformity of the inversion area is small.

### EFFECT OF THE INVENTION

According to methods for manufacturing a periodically poled structure in a ferroelectric substrate in the present invention, a uniform periodically poled structure can be manufactured, in which non-uniformity of the inversion area is small.

### EXAMPLES

The present invention will be described specifically below by way of Examples. However, the present invention is not restricted to these Examples.

Incidentally, in the following examples, a periodically poled structure in a ferroelectric substrate was manufactured utilizing the manufacturing device A illustrated in FIG. 1.

### Example 1

In the manufacturing device A of FIG. 1, a ferroelectric substrate 4 made of a KNbO₃ single crystal in which the spontaneous polarization is generally arranged in the thick direction was used.

Patterns are formed on the upper surface 4A of the substrate 4, which were coated with photo resist and manufactured by a photolithography method as insulating layers 5. The thickness of the substrate 4 was 1 mm while the thickness of the insulating layer 5 was 8 μm.

The ferroelectric substrate 4 on which these insulating layers 5 were formed was disposed between the acryl plates 8 through silicon rubbers 7. The first liquid electrode 1 and the second liquid electrode 2 were filled between the acryl plates 8 and the substrate 4 . When filling, adjustment has been made so that no bubble remained on the surface of the ferroelectric substrate 4 by a bubble-removing processing. As for the first liquid electrode 1 and the second liquid electrode 2, LiCl in a saturated aqueous solution was used.

First, using this manufacturing device, the first uniform core generating process was performed by applying an electric field between the substrate 4 by means of a power source 6. In this case, the first liquid electrode 1 became a positive potential and the second liquid electrode 2 became a negative potential and then an electric field having its maximum field of 350 V/mm in the pyramidal waveform was applied for 2 seconds in order to avoid breakdown of the substrate 4 or generation of undesirable domain due to abrupt change in the electric field. Due to this, an inversion charge flowed, which was corresponding to approximately 110% of the area in which the finally obtained polarization direction was the direction 12. As for the reason, it is considered that an area larger than the polarization-inverted area finally to the direction 12 was polarization-inverted to the direction 12.

Then, the second uniform core generating process was performed. The first liquid electrode 1 became a negative potential and the second liquid electrode 2 became a positive potential and then an electric field having its maximum field of 350 V/mm in the pyramidal waveform was applied for 2 seconds. Due to this, a polarization-inverted area to the direction 12 was polarization-inverted once again to the spontaneous polarization direction 11. The amount of inversion charge flowing at this time was the same as the amount of inversion charge flowing as described before. From this fact, it is considered that a polarization-inverted area to the direction 12 in the first uniform core generating process was all polarization-inverted to the spontaneous polarization direction 11.

Next, for the substrate 4 in which the first uniform core generating process and the second uniform core generating process were performed one time respectively, the first liquid electrode 1 became a positive potential and the second liquid electrode 2 became a negative potential and then an electric field of approximately 300 V/mm was applied for approximately 50 ms at a normal temperature for the positive pattern forming process.

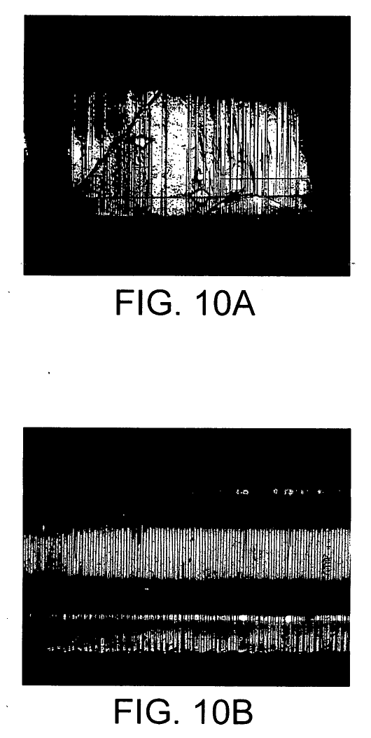

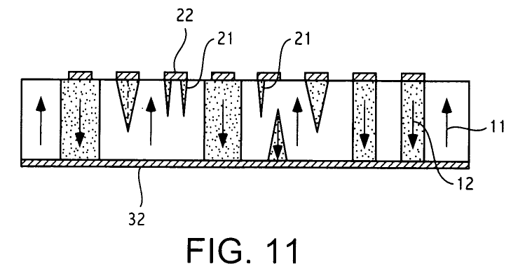

Then, a forming state of the periodically poled structure was confirmed by etching the substrate 4 with hydrofluoric acid. As a result, as shown in FIG. 10(a), the conventional method could not eliminate non-uniformity of the periodically poled structure, while according to the manufacturing method in the present invention, it was possible to manufacture the substrate in which non-uniformity of the inversion period was small and the periodically poled structure having a uniform polarization direction with a period of 30 μm was provided within the same polarization area.

### Example 2

In Example 1, a substrate having a periodically poled structure was obtained in the same manner as in Example 1 except that an electric field of approximately 350 V/mm was applied for approximately 9 ms at a normal temperature for the positive pattern forming process. Then, a forming state of the periodically poled structure was confirmed by etching the substrate 4 with hydrofluoric acid. According to the manufacturing method in the present invention, it was possible to manufacture the substrate in which non-uniformity of the inversion period was small and the periodically poled structure having a uniform polarization direction with a period of 30 μm was provided within the same polarization area.

### Example 3

In Example 1, a substrate having a periodically poled structure was obtained in the same manner as in Example 1 except that an electric field of approximately 400 V/mm was applied for approximately 5 ms for the positive pattern forming process. Then, a forming state of the periodically poled structure was confirmed by etching the substrate 4 with hydrofluoric acid. According to the manufacturing method in the present invention, it was possible to manufacture the substrate in which non-uniformity of the inversion period was small and the periodically poled structure having a uniform polarization direction with a period of 30 μm was provided within the same polarization area.

### Example 4

The same manufacturing device as in Example 1 was used.

First, the third uniform core generating process was performed by applying an electric field between the substrate 4 by means of a power source 6. In this case, the first liquid electrode 1 became a positive potential and the second liquid electrode 2 became a negative potential and then an electric field having its maximum field of 350 V/mm in the pyramidal waveform was applied for 4 seconds in order to avoid breakdown of the substrate 4 or generation of undesirable domain due to abrupt change in the electric field. Due to this, it is considered that all areas of the substrate 4 were polarization-inverted to the direction 12.

Then, the first liquid electrode 1 became a negative potential and the second liquid electrode 2 became a positive potential and then an electric field of approximately 300 V/mm was applied for approximately 50 ms for the negative pattern forming process.

Then, a forming state of the periodically poled structure was confirmed by etching the substrate 4 with hydrofluoric acid. According to the manufacturing method in the present invention, it was possible to manufacture the substrate in which non-uniformity of the inversion period was small and the periodically poled structure having a uniform polarization direction with a period of 30 μm was provided within the same polarization area.

### Example 5

The same manufacturing device as in Example 1 was used.

First, the first uniform core generating process and the second uniform core generating process were performed one time respectively in the same manner as in Example 1. Then, the third uniform core generating process was performed by applying an electric field between the substrate 4 by means of a power source 6. In this case, the first liquid electrode 1 became a positive potential and the second liquid electrode 2 became a negative potential and then an electric field having its maximum field of 350 V/mm in the pyramidal waveform was applied for 4 seconds in order to avoid breakdown of the substrate 4 or generation of undesirable domain due to abrupt change in the electric field. Due to this, it is considered that all areas of the substrate 4 are polarization-inverted to the direction 12.

Then, the first liquid electrode 1 became a negative potential and the second liquid electrode 2 became a positive potential and then an electric field of approximately 300 V/mm was applied for approximately 50 seconds for the negative pattern forming process.

Then, a forming state of the periodically poled structure was confirmed by etching the substrate 4 with hydrofluoric acid. According to the manufacturing method in the present invention, it was possible to manufacture the substrate in which non-uniformity of the inversion period was small and the periodically poled structure having a uniform polarization direction with a period of 30 μm was provided within the same polarization area.

### Example 6

The same manufacturing device as in Example 1 was used.

First, the third uniform core generating process was performed by applying an electric field between the substrate 4 by means of a power source 6. In this case, the first liquid electrode 1 became a positive potential and the second liquid electrode 2 became a negative potential and then an electric field having its maximum field of 350 V/mm in the pyramidal waveform was applied for 4 seconds in order to avoid breakdown of the substrate 4 or generation of undesirable domain due to abrupt change in the electric field. Due to this, it is considered that all areas of the substrate 4 were polarization-inverted to the direction 12.

Then, the second uniform core generating process was performed. The first liquid electrode 1 became a negative potential and the second liquid electrode 2 became a positive potential and then an electric field having its maximum field of 350 V/mm in the pyramidal waveform was applied for 2 seconds. Due to this, a polarization-inverted area to the direction 12 was polarization-inverted once again to the spontaneous polarization direction 11. The third uniform core generating process and the second uniform core generating process were performed one time respectively.

Furthermore, the third uniform core generating process was performed in the same manner as in the above.

Then, the first liquid electrode 1 became a negative potential and the second liquid electrode 2 became a positive potential and then an electric field of approximately 300 V/mm was applied for approximately 50 ms for the negative pattern forming process. Then, a forming state of the periodically poled structure was confirmed by etching the substrate 4 with hydrofluoric acid. According to the manufacturing method in the present invention, it was possible to manufacture the substrate in which non-uniformity of the inversion period was small and the periodically poled structure having a uniform polarization direction with a period of 30 μm was provided within the same polarization area.

### Example 7

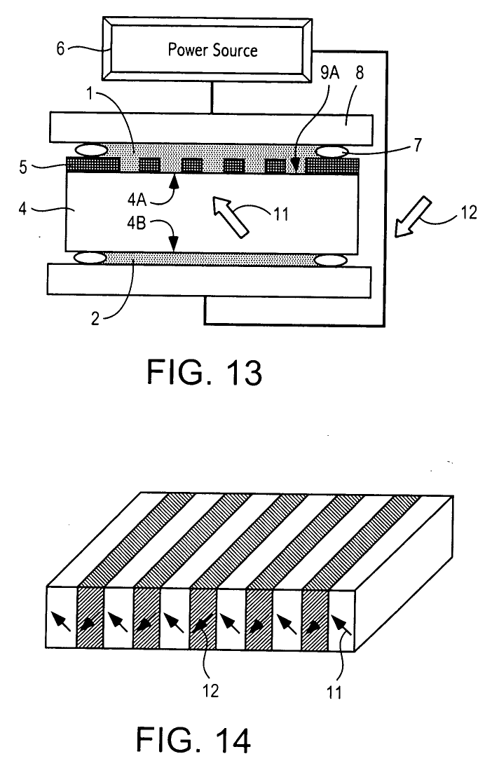

Reference was made to an enlarged schematic perspective view of FIG. 13. As shown in a diagram of FIG. 14, here was presented an example where a structure having an angle of 90° between the first polarization direction 11 and the second polarization direction 12 was manufactured. In case of FIG. 13, the substrate 4 which has the first polarization direction 11 leaning 45° to the surface of the substrate 4 comprises the first electrode 1 consisted of a pattern coated with photo resist and manufactured by a photolithography method as insulating layers 5 on the main surface of the substrate 4 of the polarization, and LiCl in a saturated aqueous solution; the second electrode 2 made by contacting only LiCl in a saturated aqueous solution with the substrate 4.

In this example, the substrate 4 was disposed between the acryl plates 8 through the silicon rubbers 7. LiCl in a saturated aqueous solution was filled between the acryl plates 8 and the substrate 4. When filling, adjustment has been made so that no bubble remained on the surface of the substrate 4 by a bubble-removing processing.

Then, the first uniform core generating process was performed by applying an electric field between the substrate 4 by means of a power source 6. In this case, the thickness of the substrate 4 was 1 mm and the thickness of the photo resist was 8 μm. The electrode 1 became a positive potential and the electrode 2 became a negative potential and then an electric field having its maximum field of 180 V/mm in the pyramidal waveform was applied for 1000 seconds in order to avoid breakdown of the substrate 4 or generation of undesirable domain due to abrupt change in the electric field. Due to this, an inversion charge flowed, which was corresponding to approximately 110% of the area in which the finally obtained polarization direction was the second polarization direction 12. Next, the second uniform core generating process was performed. The electrode 1 became a negative potential and the electrode 2 became a positive potential and then an electric field having its maximum field of 180 V/mm in the pyramidal waveform was applied and the forward-switched area to the second polarization direction 12 is backward-switched to the first polarization direction 11. The amount of inversion charge flowing at this time was the same as the amount of inversion charge flowing as described before. From this fact, it is considered that an area that was forward-switched to the second polarization direction 12 in the first uniform core generating process was all backward-switched to the first polarization direction 11 by the second uniform core generating process.

As for the electric field waveforms used for the first uniform core generating process, the second uniform core generating process and the third uniform core generating process, any of a sine waveform and a square waveform may be used in addition to the above pyramidal waveform. In any of these cases, it is desirable that an electric field greater than the inversion-initiating electric field was applied and an electric field was applied until the current flowing during the inversion became zero.

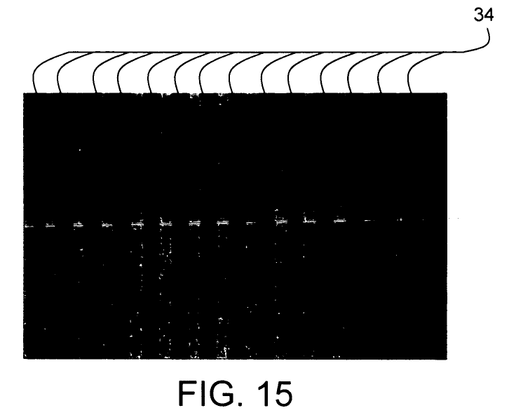

Next, for the substrate 4 in which the first uniform core generating process and the second uniform core generating process were performed one time respectively, the electrode 1 became a positive potential and the electrode 2 became a negative potential and then an electric field of approximately 200 V/mm was applied for approximately 1000 ms for the positive pattern forming process. In this way, formation of the polarization structure having a desired pattern was tested and a forming state of the polarization pattern was confirmed from the surface of the manufactured substrate 4 using a transmission optical microscope. As a result, as shown in FIG. 15, the polarization-inverted area 34 was obtained, and the polarization structure having a period of 18 μm and 1 mm in thickness could be manufactured in which non-uniformity in the inversion period was small and the polarization direction was uniform within the same polarization area.

Industrial Applicability

The present invention relates to a method for manufacturing optical devices such as a wavelength conversion element, a second harmonic generation element and the like; these optical devices can be used for optical communications, optical information recording, optical measurement and the like.

1. A method for manufacturing a periodically poled structure in a ferroelectric substrate wherein an electrode-formed substrate having electrodes respectively on both surfaces of the ferroelectric substrate in which a spontaneous polarization is arranged in one polarization direction and having electrodes on at least one surface formed in the teeth of comb at a predetermined distance in the surface direction is used, and an electric field is applied between electrodes on both surfaces of the substrate to form a structure such that the polarization direction is periodically inverted,
wherein a process of applying the electric field whose waveform is selected among a pyramidal waveform, a sine waveform, a square waveform, in the direction different from a spontaneous polarization between the electrodes and then applying the electric field whose waveform is a square waveform in the same direction as the spontaneous polarization between the electrodes is performed at least one or more times, and the electric field is further applied in the direction different from the spontaneous polarization.

2. A method for manufacturing a periodically poled structure in a ferroelectric substrate wherein an electrode-formed substrate having electrodes respectively on both surfaces of the ferroelectric substrate in which a spontaneous polarization is arranged in one polarization direction and having electrodes on at least one surface formed in the teeth of comb at a predetermined distance in the surface direction is used, and an electric field is applied between electrodes on both surfaces of the substrate to form a structure such that the polarization direction is periodically inverted,
wherein the electric field whose waveform is selected among a pyramidal waveform, a sine waveform, a square waveform, is applied in the direction different from the spontaneous polarization between the electrodes and the electric field whose waveform is a square waveform is further applied in the same direction as the spontaneous polarization.

3. A method for manufacturing a periodically poled structure in a ferroelectric substrate according to claim 2, wherein an electric field whose waveform is selected among a pyramidal waveform, a sine waveform, a square waveform is applied in the direction different from the spontaneous polarization before the electric field whose waveform is selected among a pyramidal waveform, a sine waveform, a square waveform is applied in the direction different from the spontaneous polarization and then a process of applying the electric field whose waveform is a square waveform in the same direction as the spontaneous polarization is performed repeatedly at least one or more times.

4. A method for manufacturing a periodically poled structure in a ferroelectric substrate according to claim 2, wherein the electrode-formed substrate is a substrate which insulating layers and/or pattern electrodes are formed on the surface thereof.

5. A method for manufacturing a periodically poled structure in a ferroelectric substrate according to claim 2, wherein the angle between the spontaneous polarization direction and the inverted polarization direction is 60°, 90°, 120° or 180°.

6. A method for manufacturing a periodically poled structure in a ferroelectric substrate according to claim 2, wherein the ferroelectric substrate is an oxide single crystal.

7. A method for manufacturing a periodically poled structure in a ferroelectric substrate according to claim 6, wherein the oxide single crystal is a single crystal which is formed with lithium niobate, lithium tantalate or a compound mixing transitional metal with these.

8. A method for manufacturing a periodically poled structure in a ferroelectric substrate according to claim 6, wherein the oxide single crystal is an orthorhombic crystal or a tetragonal crystal.

9. A method for manufacturing a periodically poled structure in a ferroelectric substrate according to claim 8, wherein the oxide single crystal is a potassium niobate single crystal, a potassium titanyl phosphate single crystal, a lithium triborate single crystal or a barium titanate single crystal.

10. A method for manufacturing a periodically poled structure in a ferroelectric substrate according to claim 1, wherein the electrode-formed substrate is a substrate which insulating layers and/or pattern electrodes are formed on the surface thereof.

11. A method for manufacturing a periodically poled structure in a ferroelectric substrate according to claim 1, wherein the angle between the spontaneous polarization direction and the inverted polarization direction is 60°, 90°, 120° or 180°.

12. A method for manufacturing a periodically poled structure in a ferroelectric substrate according to claim 1, wherein the ferroelectric substrate is an oxide single crystal.

13. A method for manufacturing a periodically poled structure in a ferroelectric substrate according to claim 12, wherein the oxide single crystal is a single crystal which is formed with lithium niobate, lithium tantalate or a compound mixing transitional metal with these.

14. A method for manufacturing a periodically poled structure in a ferroelectric substrate according to claim 12, wherein the oxide single crystal is an orthorhombic crystal or a tetragonal crystal.

15. A method for manufacturing a periodically poled structure in a ferroelectric substrate according to claim 14, wherein the oxide single crystal is a potassium niobate single crystal, a potassium titanyl phosphate single crystal, a lithium triborate single crystal or a barium titanate single crystal.
